(19) United States
(12) Patent Application Publication
(10) Pub. No.: US 2024/0275110 A1
(43) Pub. Date: Aug. 15, 2024

(54) COAXIAL CABLE CONNECTOR

(71) Applicant: EZCONN CORPORATION, NEW TAIPEI CITY (TW)

(72) Inventors: Chi Bin HUANG, NEW TAIPEI CITY (TW); Han Chung CHEN, NEW TAIPEI CITY (TW)

(21) Appl. No.: 18/647,145

(22) Filed: Apr. 26, 2024

Related U.S. Application Data
(63) Continuation-in-part of application No. 18/178,296, filed on Mar. 3, 2023.
(60) Provisional application No. 63/316,446, filed on Mar. 4, 2022.

(51) Int. Cl. H01R 24/40; H01R 13/623; H01R 103/00

(52) U.S. Cl. CPC H01R 24/40; H01R 13/623; H01R 2103/00

(57) ABSTRACT

A coaxial cable connector suitable for mating with an end portion of an electronic device comprises a spindle and a sleeve. The spindle includes a head and a body, wherein the head and the body are coaxially sleeved onto each other. The sleeve is coaxially sleeved onto the spindle, and it includes a head portion, a stopper portion, a compression portion, and a sleeving portion, with the head portion and the body portion of the spindle being disposed between the head portion and the stopper portion. When the coaxial cable connector is joined to the electronic device, the head portion is used to electrically contact the end portion of the electronic device. During installation or removal of the coaxial cable connector from the electronic device, only by rotating the sleeving portion can the head portion be rotated to a specific position. Moreover, in a specific configuration, after the sleeve is locked to the electronic device, a mechanism similar to a ratchet sliding is utilized to provide indication of completed locking.

### FIELD OF INVENTION

This invention relates to a connector, particularly a coaxial cable connector, which provides consistent and reliable electrical connectivity without the need for special compression tools for installation and removal.

### PRIOR ART

Coaxial cable connectors, in addition to being applied in the reception of cable television signals, are commonly used in the field of broadband communication. A typical coaxial cable connector 9, as shown in FIG. 1, includes a spindle 91, an outer sleeve 92, a nut 93, and a compression sleeve 94. The front end 921 of the outer sleeve 92 surrounds and contacts the outer peripheral surface of the spindle 91, and the rear end 922 of the outer sleeve 92 cooperates with the spindle 91 to define a space 923 for partially inserting a coaxial cable 8. The nut 93 can be freely rotated and fixed on the spindle 91 and the outer sleeve 92. The compression sleeve 94 needs to be pressed by a professional compression tool (not shown in the figure) to force the rear end 922 of the outer sleeve 92 towards the spindle 91 to prevent the coaxial cable 8 from coming off.

In the known coaxial cable connector 9, when connected to a connector 71 of an electronic device 7, the internal thread 931 of the nut 93 is connected to the surface 711 of the threaded portion of the connector 71 by tightening the nut 93. By tightening the nut 93, the central conductor 81 of the coaxial cable 8 is electrically connected to the central channel 712 of the connector 71, allowing the electronic device 7 and the coaxial cable connector 9 to form both electrical and mechanical connections.

It is known that when the coaxial cable connector 9 is connected to the connector 71 of the electronic device 7, poor electrical contact often occurs. The reason is that the nut 93 may loosen over time due to various factors and fail to make full contact with the spindle 91. These factors include that even when locked to the bottom during rotation, it does not guarantee tight contact between the connector 71 and the spindle 91, or there may be gaps due to external pulling or vibration, causing intermittent poor electrical conductivity issues. This allows other external signals to potentially infiltrate. Therefore, there are related improvement methods which involve adding elastic conductive elements 95 between the nut 93, spindle 91, and the connector 71 of the electronic device 7, so that these components can make close contact with each other. However, even with the addition of different structures of elastic conductive elements 95, users often need to tighten the nut 93 and the connector 71 of the electronic device 7 to a certain extent before ensuring electrical conductivity. In other words, known coaxial cable connectors 9 cannot establish electrical conductivity at the beginning. As a result, intermittent electrical conductivity may introduce unnecessary electrical interference when external signals are present, affecting signal transmission quality.

Furthermore, known coaxial cable connectors 9 require the use of special compression tools. This poses an additional cost for users to purchase professional tools, and even with the tools, users cannot easily, intuitively, and efficiently use them. Therefore, addressing the aforementioned issues and providing users with a more satisfactory product becomes a crucial problem that this invention seeks to solve.

### SUMMARY

An objective of the present invention is to provide a coaxial cable connector capable of addressing at least one drawback in the prior art.

Therefore, the coaxial cable connector of the present invention is designed for coupling to one end of an electronic device. The coaxial cable connector comprises a spindle and a sleeve.

A spindle includes a head and a body. The head and the body are coaxially sleeved onto each other.

A sleeve is coaxially sleeved onto the spindle. The sleeve comprises a head portion, a stopper portion, a compression portion, and a sleeving portion, wherein the head portion and the body portion of the spindle are disposed between the head portion and the stopper portion. The head portion of the sleeve comprises a first end and a first locking device. The sleeving portion comprises a covering member and a second locking device, and wherein the second locking device is disposed on the inner surface of the covering member. The first end is connected to the end portion of the electronic device. When the coaxial cable connector is joined to the electronic device, the head portion electrically contacts the end portion of the electronic device. When the sleeving portion bears torque, the second locking device drives the first locking device to rotate synchronously. The rotation of the sleeving portion causes the head portion of the sleeve to move from a first relative position to a second relative position with respect to the end portion of the electronic device, simultaneously the body portion moves from a first position to a second position. When the head portion reaches the second relative position, the sleeving portion continues to bear the torque and cannot further drive the head portion to rotate, and it causes the second locking device to undergo misaligned sliding with respect to the first locking device.

Another sleeve disclosed is coaxially sleeved onto the spindle. The sleeve comprises a head portion, a stopper portion, a compression portion, a sleeving portion, and a locking portion, wherein the head portion and the body portion of the spindle are disposed between the head portion and the stopper portion. The head portion of the sleeve comprises a first end and a first locking device. The sleeving portion comprises a covering member and a second locking device. The second locking device is disposed on the inner surface of the covering member, and the locking portion being correspondingly disposed on at least one of the first locking device and the second locking device. The locking portion comprising at least one component, and wherein the first end is connected to the end portion of the electronic device. When the coaxial cable connector is joined to the electronic device, the head portion electrically contacts the end portion of the electronic device. When the sleeving portion bears torque, the first locking device and the second locking device rotate synchronously via the components of the locking portion. The rotation of the sleeving portion causes the head portion of the sleeve to move from a first relative position to a second relative position with respect to the end portion of the electronic device, simultaneously the body portion moves from a first position to a second position. When the head portion reaches the second relative position, the sleeving portion continues to bear the torque and cannot further drive the head portion to rotate, and it causes at least one of the first locking device and the second locking device and the components to undergo misaligned sliding.

Another sleeve disclosed is coaxially sleeved onto the spindle, The sleeve comprises a head portion, a stopper portion, a compression portion, and a sleeving portion, and with the head portion and the body portion of the spindle being disposed between the head portion and the stopper portion. Further, the head portion of the sleeve includes a first end and a second end. The sleeving portion includes a covering member and a third end, wherein the third end is correspondingly connected to the second end, and the first end is correspondingly connected to the end portion of the electronic device. The coaxial cable connector is characterized in that when joined to the electronic device, the head portion electrically contacts the end portion of the electronic device, and the sleeving portion is tightly coupled to the head portion. When the sleeving portion bears a torque, the rotation of the sleeving portion drives the head portion to rotate synchronously, it causes the head portion of the sleeve to move from a first relative position to a second relative position with respect to the end portion of the electronic device, while the body portion moves from a first position to a second position.

The clarity of these and other components, steps, features, advantages, and benefits of the present invention will become apparent through the detailed description provided below, which includes illustrative embodiments and accompanying drawings, and the scope of the claimed invention as set forth in the patent claims.

### BRIEF DESCRIPTION OF THE DRAWINGS

Additional features and functionalities of the present invention will be clearly presented in the exemplary embodiments referenced in the accompanying drawings, wherein:

FIG. 1 is a sectional view of a conventional coaxial cable connector joined to a coaxial cable;

FIG. 2A is an exploded perspective view of an embodiment of the coaxial cable connector according to the present invention;

FIG. 2B is a partial structural sectional view of the coaxial cable connector according to the embodiment illustrated in FIG. 2A;

FIG. 3A is an exploded perspective view of another embodiment of the coaxial cable connector according to the present invention;

FIG. 3B is a partial structural sectional view of the coaxial cable connector according to the embodiment illustrated in FIG. 3A;

FIG. 4A is an exploded perspective view of another embodiment of the coaxial cable connector according to the present invention;

FIG. 4B is a partial structural sectional view of the coaxial cable connector according to the embodiment illustrated in FIG. 4A;

FIG. 5 and FIG. 6 are structural sectional views of the coaxial cable connector connected to electronic devices before and after connection, respectively, as illustrated in FIG. 2;

FIG. 7A is an exploded perspective view of another embodiment of the coaxial cable connector according to the present invention;

FIG. 7B is a partial structural sectional view of the coaxial cable connector according to the embodiment illustrated in FIG. 7A;

FIG. 8 is a structural sectional view of the coaxial cable connector according to the embodiment illustrated in FIG. 7A.

### DETAILED DESCRIPTION

Before delving into the detailed description of the present invention, it should be noted that similar elements are denoted by the same reference numerals throughout the following disclosure. Additionally, shapes, dimensions, thicknesses, angles, and other related parameters of the components in the figures are not drawn to scale. The simplification is for the purpose of clear illustration and ease of explanation.

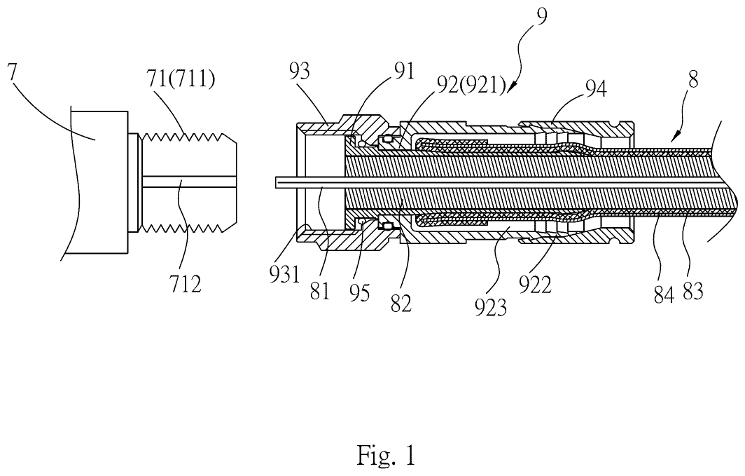

The coaxial cable 8 used in the coaxial cable connector disclosed in the present invention is the same with the conventional cable, thus, the cross-sectional view of a coaxial cable 8 can be as shown in FIG. 1. The coaxial cable 8 radially outwardly includes a central conductor 81, an insulating layer 82, a shielding layer (not shown), a braided layer 83, and a plastic sheath 84. The central conductor 81 is made of materials such as copper, iron, silver, nickel, gold, copper-gold alloy, copper-tin alloy, copper-nickel alloy, or other conductive polymers or non-metallic conductors with good conductivity. The braided layer 83 is made of a material containing aluminum, a metallic layer containing copper, or a conductive layer containing conductive substances, such as an aluminum wire wrapping layer or a copper wire wrapping layer. The braided layer 83 has electrical shielding effects to reduce interference, and its forms include double braiding (Standard), triple braiding (Tri-shield), and quadruple braiding (Quad), among other different wrapping configurations. It is important to note that the materials, shapes, dimensions, and other parameters of the coaxial cable 8 components are not drawn to scale for simplification and clarity in the illustration.

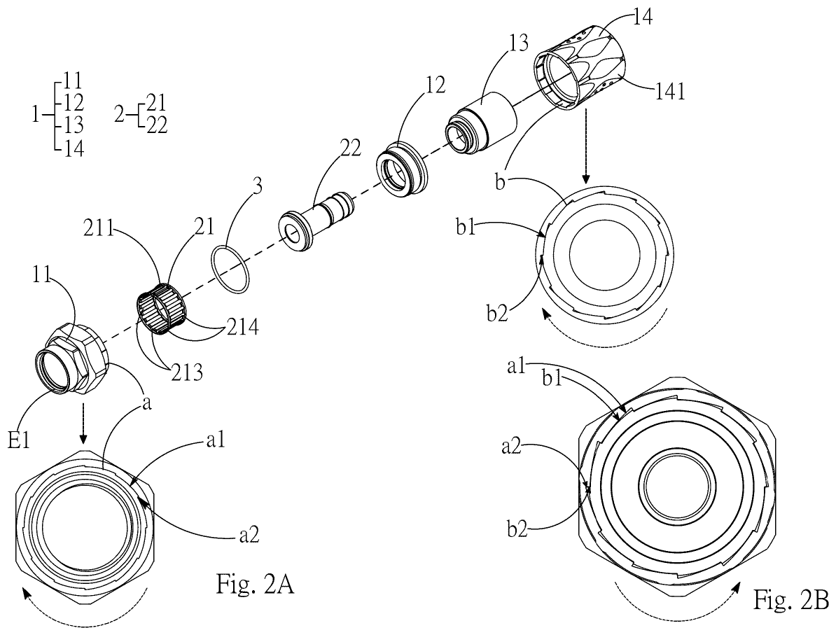

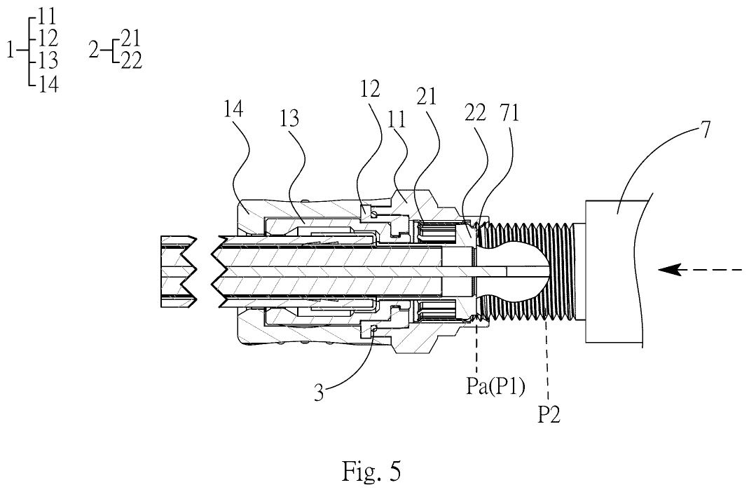

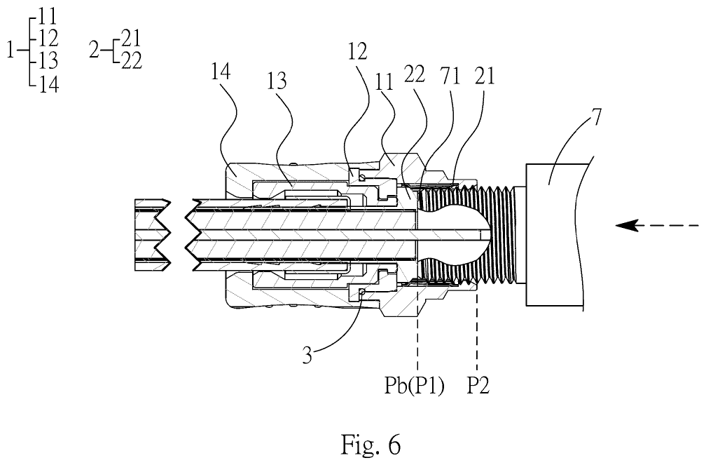

Please refer to both FIG. 2A, FIG. 2B, and FIG. 5 and FIG. 6 for the first embodiment of the present coaxial cable connector. The present coaxial cable connector is suitable for coupling to an electronic device 7, which has an end portion 71. Of course, the end portion 71 of the electronic device 7 may have a smooth surface or a textured surface in addition to the threaded surface shown in FIG. 1. The coaxial cable connector disclosed herein comprises a sleeve 1 and a spindle 2, wherein the sleeve 1 includes a head portion 11, a stopper portion 12, a compression portion 13, and a sleeving portion 14, while the spindle 2 includes a head portion 21 and a body portion 22.

In this embodiment, the sleeve 1 is coaxially sleeved outside the spindle 2, with the head portion 21 and body portion 22 of the spindle 2 positioned between the head portion 11 and stopper portion 12. The head portion 11 of the sleeve 1 includes a first end E1 and a first locking device a, while the sleeving portion 14 includes a covering member 141 and a second locking device b, with the second locking device b positioned on the inner surface of the covering member 141. The first end E1 is correspondingly connected to the end portion 71 of the electronic device 7.

When assembling this coaxial cable connector, first assemble the compression portion 13 with the stopper portion 12, then connect the head portion 21 to the head portion 11 internally. Assemble the body portion 22 to the assembled compression portion 13 and stopper portion 12, and further assemble the abovementioned parts to the assembled head portion 21 and head portion 11. At this point, the head portion 11 interferes with the stopper portion 12, the head portion 21 closely contacts the body portion 22. Finally, inserting the sleeving portion 14 from one side of the compression portion 13 into the end portion 11 completes the assembly of the coaxial cable connector. As shown in FIG. 5, in the assembled structure of the coaxial cable connector, a surface of the body portion 22 in contact with the end portion 71 of the electronic device 7 is located at position Pa.

The feature of this invention is that when the coaxial cable connector is coupled to the electronic device 7, as the coaxial cable connector is locked into the end portion 71 of the electronic device 7 along the direction indicated by the dashed arrows in FIG. 5 and FIG. 6, the relative positions of the end portion 71 of the electronic device 7 and the coaxial cable connector are as shown in the figure. Position P1 is close to the head portion 11 of the coaxial cable connector, while position P2 is still at a distance from the head portion 11. The surface contacted with the end portion 71 of the electronic device 7 of the body portion 22 is positioned at position Pa in the coaxial cable connector. In this embodiment, the position P1 is substantially at the same position of the position Pa. Users rotate the sleeving portion 14 to drive the head portion 11 to rotate, as indicated by the dashed arrows in FIG. 2A and FIG. 2B. Specifically, as rotating in the direction indicated by the dashed lines in FIG. 2A (clockwise direction), face a1 of the first locking device a of the head portion 11 is in contact with corresponding face b1 of the second locking device b. The first locking device a and the second locking device b are structurally interlocked with each other, so when the sleeving portion 14 bears torsional force, the interlocked first locking device a and second locking device b rotate simultaneously. At the same time, as the head portion 11 of the coaxial cable connector gradually moves from relative position P1 to relative position P2 with respect to the end portion 71 of the electronic device 7, the body portion 22 is pushed by the end portion 71 of the electronic device 7 so that the surface contacted with the end portion 71 of the electronic device 7 of the body portion 22 from position Pa to position Pb. And at this moment, the position P1 is substantially at the same position of the position Pb. The body portion 22 slides past the head portion 21 and tightly adheres to the end portion 71 of the electronic device 7. Furthermore, although in this embodiment, the position P2 does not have a substantial correlation with positions Pa and Pb, in fact, the relative relationships between the positions P1, P2, positions Pa, and Pb are not limiting the scope of the present invention and are only used for illustration purposes in the embodiment.

When the coaxial cable connector moves from relative position P1 to relative position P2 of the end portion 71 of the electronic device 7, it indicates that the coaxial cable connector has been securely locked to the end portion 71 of the electronic device 7. However, according to the first locking device a and second locking device b as shown in this embodiment, when the head portion 11 is fully locked to the end portion 71 of the electronic device 7, due to the spring-back of the sleeving portion 14, the faces a1 and inclined surfaces a2 of the first locking device a continuously slide against the faces b1 and inclined surfaces b2 of the second locking device b, causing misalignment under continued torsional force, resulting in a tactile sense of looseness and tightness. The sliding friction between the faces a1 and a2 of the first locking device a and the faces b1 and b2 of the second locking device b generates a “click” sound, serving as a judgment basis for whether the head portion 11 has been fully tightened to the end portion 71 of the electronic device 7 or can continue to be rotated.

Additionally, when it is desired to detach the coaxial cable connector of this embodiment from the end portion 71 of the electronic device 7, under the reverse torsional force (rotating counterclockwise as indicated by the dashed line force direction in FIG. 2B), the inclined surface b2 of the second locking device b engages with the inclined surface a2 of the first locking device a. Under the action of the reverse torsional force, the sleeving portion 14 drives the head portion 11 to rotate synchronously, thereby disengaging the coaxial cable connector from the end portion 71 of the electronic device 7. It is noteworthy that when disassembling the coaxial cable connector from the electronic device, there will be no overcutting when the second locking device b and the first locking device a′ are rotated counterclockwise. In contrast, the sleeve portion 14 and the end portion 11 is not misaligned during operation. The body portion 22 has moved from position Pa to position Pb during the installation steps, even after the coaxial cable connector is detached from the electronic device 7, it will not return to position Pa.

Since the central conductor of the coaxial cable extends from the body 22 of the spindle 2 through the head 21 to the central channel inside the end portion of the electronic device, the central conductor of the coaxial cable, along with the insulation layer and shielding layer, is accommodated within the body 22 of the spindle 2. The space surrounded by the body 22 of the spindle 2 and the sleeve 1 is used to accommodate the braided layer and plastic sheath of the coaxial cable.

The material of the head 21 and body 22 of the spindle 2 is conductive, such as copper, iron, silver, nickel, gold, copper-gold alloy, copper-tin alloy, copper-nickel alloy, or other conductive polymers or non-metallic conductors with good conductivity. The materials of the head portion 11, stopper portion 12, compression portion 13, and sleeving portion 14 of the sleeve 1 are chosen based on specific requirements and designs. They may consist of non-metallic materials (such as plastic), metallic materials, or composite materials (such as plastic/metal), depending on practical needs and design considerations.

In this embodiment, the head portion 21 and the body portion 22 are two-piece components and are detachably connected to each other, but in some embodiments, the head portion 21 and the body portion 22 may also be integrally formed. The head portion 21 of the spindle 2 is conductive and is used to directly contact the end portion (not shown) of the electronic device. When the coaxial cable connector is not fully installed in the end portion of the electronic device, the head portion 21 and the end portion of the electronic device are already in electrical contact with each other. The head portion 21 of the spindle 2 has a circumferential wall 211 and multiple grooves 213. The circumferential wall 211 of the spindle 2 has two side edges 214, and in the free state, the minimum inner diameter of the circumferential wall 211 is smaller than the outer diameter of the end portion of the electronic device. In this embodiment, the grooves 213 are formed in the circumferential wall 211 and extend axially, but the grooves 213 do not communicate with the two sides corresponding to the circumferential wall 211, thus presenting a closed opening shape in shape. In some embodiments, the head portion of the spindle may have a groove that communicates with the opposite side edges of the circumferential wall, thereby making the head portion of the spindle appear C-shaped in a frontal view.

In order to achieve good electrical connection and air tightness, the user can directly rotate and lock the head portion 11, stopper portion 12, compression portion 13, and sleeving portion 14 of the sleeve 1 to nearly completely eliminate the gap between the body portion 22 of the spindle 2 and the head portion 11, stopper portion 12, and compression portion 13, thereby achieving air tightness. Of course, to further improve the airtightness of the connector, at the initial assembly, a sealing member 3 is provided in the head portion 11 and the stopper portion 12 of the sleeve 1, with opposite sides of the sealing member 3 being pressed against the head portion 11 and the stopper portion 12 of the sleeve 1, respectively, to fill the gaps existing in the structure of the head portion 11 and the stopper portion 12.

In the coaxial cable connector of the present invention, both the body portion 22 of the spindle 2 used for threading the coaxial cable and the coaxial cable itself are simultaneously subjected to the compressive force provided by the compression portion 13 in the radial direction, thereby preventing the coaxial cable from detaching from the connector. Thus, users can install the coaxial cable connector of the present invention on the end portion of the electronic device without the need for special compression tools.

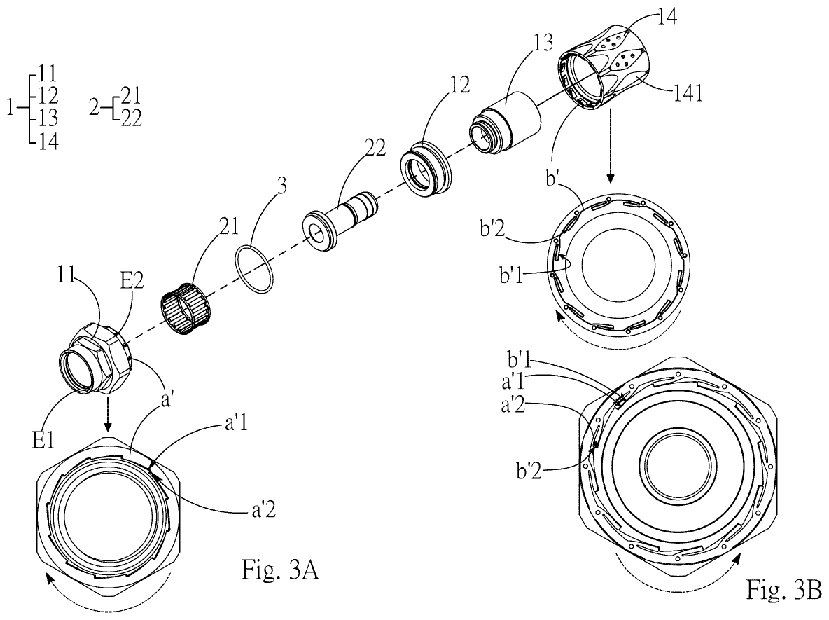

In FIGS. 3A and 3B, another embodiment of the first locking device a′ and the second locking device b′ is disclosed. In this embodiment, the first locking device a′ and the second locking device b′ are also similar to a ratchet structure, but unlike in FIG. 2, the first locking device a′ on the head portion 11 in this embodiment includes a face a′1 and an inclined surface a′2, while the second locking device b′ on the sleeving portion 14 includes an elastic arm b′1 and a bent end b′2. When the coaxial cable connector is locked into the end portion of the electronic device (not shown in FIGS. 3A and 3B), the user rotates the sleeving portion 14 to drive the head portion 11 to rotate. The face a′1 of the first locking device a′ on the head portion 11 contacts the elastic arm b′1 of the corresponding second locking device b′ on the sleeving portion 14, and the inclined surface a′2 of the first locking device a′ on the head portion 11 engages with the bent end b′2 of the corresponding second locking device b′ on the sleeving portion 14. Therefore, when the sleeving portion 14 is subjected to torque, as indicated by the dashed arrows in FIGS. 3A and 3B, the engaged first locking device a′ and second locking device b′ rotate simultaneously until the coaxial cable connector is locked to the end portion of the electronic device. Subsequently, due to the sleeving portion 14 returning to its original position, under continued torque, the elastic arm b′1 and bent end b′2 of the second locking device b′ continue to slide relative to the corresponding face a′1 and inclined surface a′2 of the first locking device a′, resulting in a corresponding sensation of looseness and tightness and generating a “click” sound due to the sliding friction between the face a′1 and inclined surface a′2 of the first locking device a′ and the elastic arm b′1 and bent end b′2 of the second locking device b′, serving as a basis for determining whether the head portion 11 is completely locked to the end portion of the electronic device or can still be further rotated.

Similarly, as described above, when disassembling the coaxial cable connector of this embodiment from the end portion of the electronic device, the engaged head portion 11 and sleeving portion 14 experience reverse torque (rotating counterclockwise as indicated by the dashed line force direction in FIG. 3B). In this situation, the bent end b′2 of the second locking device b′ engages with the inclined surface a′2 of the first locking device a′, and under the action of reverse torque, the sleeving portion 14 drives the head portion 11 to rotate synchronously, thereby loosening the coaxial cable connector from the end portion of the electronic device. It is noteworthy that when disassembling the coaxial cable connector from the electronic device, there will be no overcutting when the second locking device b′ and the first locking device a′ are rotated counterclockwise. In contrast, the sleeve portion 14 and the end portion 11 is not misaligned during operation.

Furthermore, the first locking devices a, a′ and the second locking devices b, b′ shown in FIGS. 2A and 3A respectively are fixedly arranged on the head portion 11 and the sleeving portion 14, and when locking or disassembling the sleeve 1 and the electronic device's end portion, they are driven only by directly contacting each other. Of course, in other design requirements, at least one of the first locking device and the second locking device can be fixedly arranged on the head portion or the sleeving portion, while the other component is movably arranged on the corresponding structure. For example, the first locking device can be fixedly arranged on the head portion while the second locking device is movably arranged on the sleeving portion, or the second locking device can be fixedly arranged on the sleeving portion while the first locking device is movably arranged on the head portion.

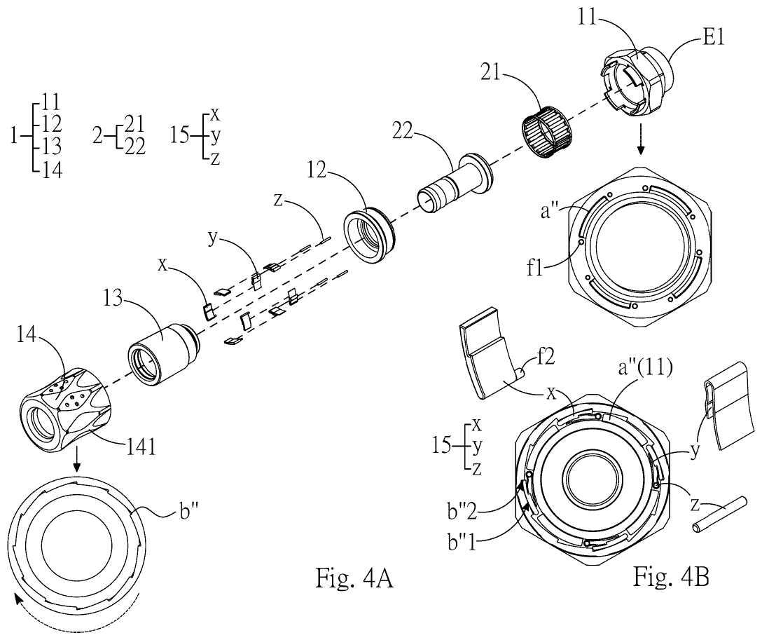

Please refer to FIGS. 4A and 4B, where a different embodiment from the previous example is illustrated. In FIGS. 4A and 4B, the sleeve 1 comprises a head portion 11, a stopper portion 12, a compression portion 13, a sleeving portion 14, and a locking portion 15. The head portion 11 of the sleeve 1 includes a first end E1 and blocks a″, with each block a″ having holes f1 at both ends. The holes f1 may have the same diameter, different diameters, or partially the same diameter. The sleeving portion 14 comprises a covering member 141 and a second locking device b″, with each second locking device b″ having a face b″1 and an inclined surface b″2. The locking portion 15 is correspondingly positioned between the first locking device a″ and the second locking device b″ and includes components x, y, and z. The column f2 of component x corresponds to being inserted into holes f1 of the head portion 11 and also corresponds to being inserted into holes f1 of the head portion 11. Part of component x corresponds to abutting against the face b″1 and inclined surface b″2 of the second locking device b″, while another part of component x corresponds to abutting against component y, and component z can be used to position component y while providing sufficient structural strength to component y. In practical applications, component x can be a ratchet tooth, component y can be a U-shaped spring, and component z can be a column.

When the coaxial cable connector is locked into the end portion of the electronic device (not shown in FIGS. 4A and 4B), the user rotates the sleeving portion 14 to drive the head portion 11 to rotate. The component x inserted into the head portion 11 contacts the face b″1 of the corresponding second locking device b″ on the sleeving portion 14, and the component x inserted into the head portion 11 engages with the inclined surface b″2 of the corresponding sleeving portion 14. Therefore, when the sleeving portion 14 is subjected to torque, as indicated by the dashed arrows in FIG. 4A, the head portion 11 and the sleeving portion 14 rotate simultaneously until the coaxial cable connector is locked to the end portion of the electronic device. Subsequently, due to the locking portion 15 returning to its original position, under continued torque, the face b″1 and inclined surface b″2 of the second locking device b″ continue to slide relative to the corresponding component x, and when the second locking device b″ slides relative to the component x, the component y provides space by deforming to allow the face b″1 and inclined surface b″2 of the second locking device b″ to continue sliding on the component x. Moreover, the component z is sandwiched in the structural gap of component y to enhance the structural strength of the U-shaped component y, allowing the U-shaped component y to withstand a certain degree of downward pressure. A corresponding sensation of looseness and tightness is generated under torque, and a “click” sound is produced due to the sliding friction between the face b″1 and inclined surface b″2 of the second locking device b″ and the component x, serving as a basis for determining whether the head portion 11 is completely locked to the end portion of the electronic device or can still be further rotated.

Similarly, as described above, when disassembling the coaxial cable connector of this embodiment from the end portion of the electronic device, the engaged head portion 11 and sleeving portion 14 experience reverse torque. In this situation, the inclined surface b″2 of the second locking device b″ engages with the component x, and under the action of reverse torque, the sleeving portion 14 drives the head portion 11 to rotate synchronously, thereby loosening the coaxial cable connector from the end portion of the electronic device. It is noteworthy that when disassembling the coaxial cable connector from the electronic device, there will be no overcutting when the second locking device b″ and the locking portion 15 (including x, y and z) are rotated counterclockwise. In contrast, the sleeve portion 14 and the end portion 11 is not misaligned during operation.

Furthermore, the structural design of components x, y, and z not only needs to conform to each other's sliding engagement shape but also needs to be designed in accordance with the structural morphology of blocks a″ and the second locking devices b″.

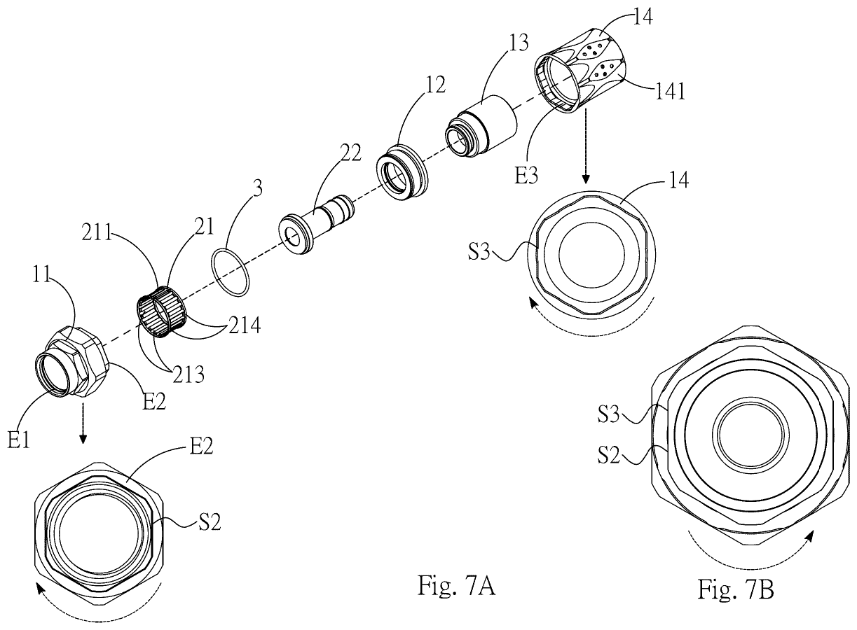

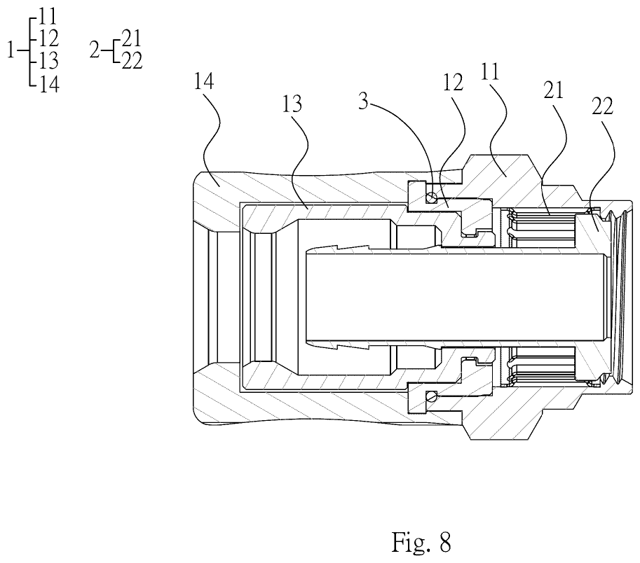

Please refer to FIGS. 7A, 7B, and 8, where in this embodiment, the coaxial cable connector comprises a sleeve 1 and a spindle 2. The sleeve 1 includes a head portion 11, a stopper portion 12, a compression portion 13, and a sleeving portion 14, while the spindle 2 includes a head portion 21 and a body portion 22.

In this embodiment, the sleeve 1 is coaxially sleeved on the periphery of the spindle 2, with the head portion 21 and the body portion 22 of the spindle 2 positioned between the head portion 11 and the stopper portion 12 of the sleeve 1. The head portion 11 of the sleeve 1 includes a first end E1 and a second end E2, while the sleeving portion 14 includes a covering member 141 and a third end E3, with the third end E3 correspondingly connected to the second end E2, and the first end E1 correspondingly connected to the end portion 71 of an electronic device 7.

When assembling this coaxial cable connector, first, the compression portion 13 is assembled with the stopper portion 12, and then the head portion 21 is connected to the head portion 11 internally. The body portion 22 is then assemble to the assembled compression portion 13 and stopper portion 12 and the abovementioned parts further assemble to the assembled head portion 21 and head portion 11. At this point, the head portion 11 and the stopper portion 12 interfere with each other, the head portion 21 contacts the body portion 22 closely. Finally, the sleeving portion 14 is inserted into the head portion 11 from one side of the compression portion 13 and the coaxial cable connector is assembled completely.

Similarly to the above, the head portion 21 and the body portion 22 are detachably connected as two-piece components, but in some embodiments, the head portion 21 and the body portion 22 can also be integrally formed. The head portion 21 of the spindle 2 is conductive and is used to directly contact the end portion of the electronic device (not shown in the figure). When the coaxial cable connector is not fully installed in the end portion of the electronic device, the head portion 21 and the end portion of the electronic device have already contacted each other and are electrically connected. The head portion 21 of the spindle 2 has a surrounding wall 211 and multiple grooves 213. The surrounding wall 211 of the spindle 2 has two side edges 214. In the free state, the minimum inner diameter of the surrounding wall 211 is smaller than the outer diameter of the end portion of the electronic device. In this embodiment, the grooves 213 are formed in the surrounding wall 211 and extend along the axial direction, but the grooves 213 do not communicate with both sides corresponding to the surrounding wall 211, thus presenting a closed opening shape. In some embodiments, the head portion of the spindle may have a groove that communicates with the opposite side edges of the surrounding wall, thereby giving the head portion of the spindle a C-shaped appearance in a frontal view.

In contrast to the previous embodiments, in this embodiment, the third end E3 of the sleeving portion 14 is in a locked state after being connected to the second end E2 of the head portion 11 because there are no similar ratchet structures on the surface S3 of the third end E3 of the sleeving portion 14 and on the surface S2 of the second end E2 of the head portion 11, instead, they are connected by mutual engagement. Therefore, although it is still possible to rotate the sleeving portion 14 to drive the head portion 11 to rotate after the coaxial cable connector is locked to a specific position (as shown in FIGS. 7A and 7B, the head portion 11 moves from relative position P1 to relative position P2), continuing to rotate the sleeving portion 14 not only cannot further drive the rotation of the head portion 11 but also does not cause sliding between the sleeving portion 14 and the head portion 11, nor does it produce a “click” sound due to friction. Although there is no auxiliary judgment provided by the previous embodiments to confirm whether the head portion 11 has been rotated to the final locked position, the actual operation does not affect the overall locking effect of the coaxial cable connector to the end portion of the electronic device, nor does it affect the electrical connection effect between the coaxial cable connector (body portion 22) and the end portion of the electronic device.

The coaxial cable connector of the present invention, when installed on an electronic device, provides continuous electrical conductivity from the beginning to the end of the installation process. Furthermore, as the body of the spindle gradually moves to its final position during the installation (completed position), the body of the spindle and the compression portion of the sleeve can mutually clamp the coaxial cable. The coaxial cable, which undergoes squeezing deformation, can be accommodated in the space between the compression portion and the body, thereby reinforcing the tensile strength of the clamped coaxial cable.

The structure of the second end of said head portion and the third end of said sleeving portion may be complementary structures, and the edges of the second end and the third end may be polygonal, circular, or other shapes. In this embodiment, a hexagonal shape is used as an example for illustration.

In addition to the structure composed of multiple components similar to the aforementioned head and body parts, the spindle of the present invention can also be formed as a single component structure. Of course, the head and body parts may form a single structure through different manufacturing processes, such as by stamping to combine the head and body parts into a single component, or the head and body parts may be joined by different connecting methods. Besides having different designs in structure, the functionality of the spindle can also be achieved using different materials. For example, the head part may be composed of an elastic body or other materials with elasticity.

Through the above description, the advantages of the coaxial cable connector of the present invention can be summarized as follows:
1. The coaxial cable connector of the present invention, whether in the initial installation or full installation process with electronic device terminals, achieves electrical contact through the contact between the head and body of the core shaft, ensuring a continuous electrical connection and providing proper shielding to prevent noise and other forms of electromagnetic interference, thus ensuring signal transmission quality.
2. The present invention does not require the use of specialized compression tools during use. Only relative movement between the sleeve and spindle is needed to reduce the surrounding space accommodating the coaxial cable, effectively preventing the cable from slipping out.
3. The sleeve of the present invention is designed with a torque-fixing mechanism. When users rotate to lock it, the torque recognition mechanism prevents structural damage due to improper operation and allows users to easily confirm if it's securely positioned.
4. The components of the present invention are ingeniously structured and easy to use, effectively reducing installation time and cost.

In summary, the coaxial cable connector of the present invention achieves electrical conductivity even before being completely tightened on the terminal of an electronic device. This ensures continuous electrical conductivity in practical use. Additionally, the present invention does not require the use of specialized compression tools, effectively preventing detachment of the coaxial cable. Therefore, the objectives of the present invention are effectively achieved.

The technical content disclosed in this creation is not limited to the embodiments mentioned above. Any concept or principle consistent with the disclosed concepts and principles falls within the scope of the patent application for this creation. It should be noted that the definitions of components, such as “first” and “second,” are not restrictive terms but rather distinctive terminology. The terms “comprising” or “including” used in this application encompass the concepts of “comprising” and “having,” indicating components, operational steps, and/or combinations thereof, without excluding or adding to their meaning.

Moreover, unless specifically stated, the order of steps in an operation does not imply absolute sequence. Also, unless explicitly stated otherwise, references to components in the singular form (e.g., using the article “a” or “an”) do not imply “one and only one” but rather “one or more.” The term “and/or” used in this application denotes “and” or “or,” as well as both “and” and “or.” The range-related terms used in this application, such as “at least,” “greater than,” “less than,” “not exceeding,” etc., refer to the upper or lower limits of the range.

However, the above descriptions are merely embodiments of the present invention, and this should not be construed as limiting the scope of the invention. Any simple equivalent variations and modifications made in accordance with the scope of the claims and the contents of the patent specification are still within the coverage of the present invention.

What is claimed is:

1. A coaxial cable connector, suitable for mating with an end portion of an electronic device, comprising:
a spindle, comprising a head and a body, wherein the head and the body are coaxially sleeved onto each other; and
a sleeve, coaxially sleeved onto the spindle, the sleeve comprising a head portion, a stopper portion, a compression portion, and a sleeving portion, wherein the head portion and the body portion of the spindle are disposed between the head portion and the stopper portion, wherein the head portion of the sleeve comprises a first end and a first locking device, wherein the sleeving portion comprises a covering member and a second locking device, and wherein the second locking device is disposed on the inner surface of the covering member, wherein the first end is connected to the end portion of the electronic device, characterized in that when the coaxial cable connector is joined to the electronic device, the head portion electrically contacts the end portion of the electronic device, when the sleeving portion bears torque, the second locking device drives the first locking device to rotate synchronously, the rotation of the sleeving portion causing the head portion of the sleeve to move from a first relative position to a second relative position with respect to the end portion of the electronic device, simultaneously the body portion moves from a first position to a second position, when the head portion reaches the second relative position, the sleeving portion continues to bear the torque and cannot further drive the head portion to rotate, causing the second locking device to undergo misaligned sliding with respect to the first locking device.

2. The coaxial cable connector of claim 1, wherein the first locking device and the second locking device can be ratchet structures.

3. The coaxial cable connector of claim 1, wherein when the sleeving portion bears the torque, the rotation of the second locking device driving the first locking device to rotate causes structural deformation in the radial direction of the sleeving portion, and the body portion moving from the first position to the second position.

4. The coaxial cable connector of claim 1, wherein when the sleeving portion bears a force opposite to the torque, the sleeving portion drives the head portion to rotate, the second locking device drives the first locking device to rotate without relative movement, causing the head portion of the sleeve to move away from the second relative position and towards the first relative position.

5. The coaxial cable connector of claim 1, wherein the first locking device and the second locking device can be respectively fixedly disposed on the head portion and the sleeving portion, or the first locking device is fixedly disposed on the head portion while the second locking device is movably disposed on the sleeving portion and corresponds to the first locking device, or the second locking device is fixedly disposed on the sleeving portion while the first locking device is movably disposed on the head portion and corresponds to the second locking device.

6. The coaxial cable connector of claim 1, wherein the head and the body are detachable or integrally formed.

7. The coaxial cable connector of claim 1, wherein a sealing member is disposed between the head portion and the stopper portion, with opposite sides of the sealing member being compressed against the head portion and the stopper portion, respectively.

8. The coaxial cable connector of claim 1, wherein the head is conductive, such that when the coaxial cable connector is not fully installed on the end of the electronic device, the head contacts and forms an electrical connection with the end of the electronic device.

9. The coaxial cable connector of claim 1, wherein the end of the electronic device has a smooth surface, a threaded surface, or a surface with irregularities.

10. A coaxial cable connector, suitable for mating with an end portion of an electronic device, comprising:
a spindle, comprising a head and a body, wherein the head and the body are coaxially sleeved onto each other; and
A sleeve, coaxially sleeved onto the spindle, the sleeve comprising a head portion, a stopper portion, a compression portion, a sleeving portion, and a locking portion, wherein the head portion and the body portion of the spindle are disposed between the head portion and the stopper portion, wherein the head portion of the sleeve comprises a first end and a first locking device, wherein the sleeving portion comprises a covering member and a second locking device, wherein the second locking device is disposed on the inner surface of the covering member, the locking portion being correspondingly disposed on at least one of the first locking device and the second locking device, the locking portion comprising at least one component, and wherein the first end is connected to the end portion of the electronic device, characterized in that when the coaxial cable connector is joined to the electronic device, the head portion electrically contacts the end portion of the electronic device, when the sleeving portion bears torque, the first locking device and the second locking device rotate synchronously via the locking portion's the components, the rotation of the sleeving portion causing the head portion of the sleeve to move from a first relative position to a second relative position with respect to the end portion of the electronic device, simultaneously the body portion moves from a first position to a second position, when the head portion reaches the second relative position, the sleeving portion continues to bear the torque and cannot further drive the head portion to rotate, causing at least one of the first locking device and the second locking device and the components to undergo misaligned sliding.

11. The coaxial cable connector of claim 10, wherein the components are selected from positioning pillars, spring plates, ratchet teeth, and combinations thereof.

12. The coaxial cable connector of claim 10, wherein when the sleeving portion bears the torque, the synchronous rotation of the first locking device and the second locking device via at least one of the sleeving portion and the components of the locking portion causes structural deformation in the radial direction of the sleeving portion, and the body portion moving from the first position to the second position.

13. The coaxial cable connector of claim 10, wherein when the sleeving portion bears a force opposite to the torque, the sleeving portion drives the head portion to rotate, causing the second locking device, the components of the locking portion, and the first locking device to rotate simultaneously without relative movement, the head portion of the sleeve moving from the second relative position to the first position with respect to the end portion of the electronic device.

14. The coaxial cable connector of claim 10, wherein the head and the body are detachable or integrally formed.

15. The coaxial cable connector of claim 10, wherein a sealing member is disposed between the head portion and the stopper portion, with opposite sides of the sealing member being compressed against the head portion and the stopper portion, respectively.

16. The coaxial cable connector of claim 10, wherein the head is conductive, such that when the coaxial cable connector is not fully installed on the end of the electronic device, the head contacts and forms an electrical connection with the end of the electronic device.

17. The coaxial cable connector of claim 10, wherein the end of the electronic device has a smooth surface, a threaded surface, or a surface with irregularities.

18. A coaxial cable connector, suitable for mating with an end portion of an electronic device, comprising:
a spindle, comprising a head and a body, wherein the head and the body are coaxially sleeved onto each other; and
A sleeve, coaxially sleeved onto the spindle, the sleeve comprising a head portion, a stopper portion, a compression portion, and a sleeving portion, wherein the head portion and the body portion of the spindle are disposed between the head portion and the stopper portion, and the head portion of the sleeve includes a first end and a second end, the sleeving portion includes a covering member and a third end, wherein the third end is correspondingly connected to the second end, and the first end is correspondingly connected to the end portion of the electronic device, and the coaxial cable connector is characterized in that when joined to the electronic device, the head portion electrically contacts the end portion of the electronic device, and the sleeving portion is tightly coupled to the head portion, when the sleeving portion bears a torque, the rotation of the sleeving portion drives the head portion to rotate synchronously, causing the head portion of the sleeve to move from a first relative position to a second relative position with respect to the end portion of the electronic device, while the body portion moves from a first position to a second position.

19. The coaxial cable connector of claim 18, wherein the first locking device and the second locking device can be ratchet structures.

20. The coaxial cable connector of claim 18, wherein when the sleeving portion bears a force opposite to the torque, the sleeving portion drives the head portion to rotate, causing the head portion of the sleeve to move from the second relative position and toward the first relative position.

21. The coaxial cable connector of claim 18, wherein the head and the body are detachable or integrally formed.

22. The coaxial cable connector of claim 18, wherein a sealing member is disposed between the head portion and the stopper portion, wherein opposite sides of the sealing member are respectively pressed against the head portion and the stopper portion.

23. The coaxial cable connector of claim 18, wherein the head is conductive, such that when the coaxial cable connector is not fully installed on the end of the electronic device, the head contacts and forms an electrical connection with the end of the electronic device.

24. The coaxial cable connector of claim 18, wherein the end of the electronic device has a smooth surface, a threaded surface, or a surface with irregularities.

25. The coaxial cable connector of claim 18, wherein the second end of the head portion comprises a first locking device.

26. The coaxial cable connector of claim 18, wherein the third end of the sleeving portion comprises a second locking device.

27. The coaxial cable connector of claim 25, wherein the third end of the sleeving portion comprises a second locking device corresponding to the first locking device.

28. The coaxial cable connector of claim 27, wherein the first locking device and the second locking device can be ratchet structures.

29. The coaxial cable connector of claim 18, the sleeve further comprises a locking portion, and the locking portion comprises at least one component.

30. The coaxial cable connector of claim 27, wherein the sleeve further comprises a locking portion, the locking portion further comprises at least one component, and wherein the component of the locking portion is positioned corresponding to the first locking device and the second locking device.

31. A coaxial cable connector as claimed of claim 18, wherein the structure of the second end of said head portion and the third end of said sleeving portion may be complementary structures, and the edges of the second end and the third end may be polygonal, circular, or other shapes.
